(19) United States
(12) Patent Application Publication
(10) Pub. No.: US 2024/0274942 A1
(43) Pub. Date: Aug. 15, 2024

(54) POWER STORAGE DEVICE

(71) Applicant: Prime Planet Energy & Solutions, Inc., Tokyo (JP)

(72) Inventor: Kazuki OSHIMA, Himeji-shi (JP)

(21) Appl. No.: 18/430,651

(22) Filed: Feb. 2, 2024

(30) Foreign Application Priority Data
Feb. 9, 2023 (JP) 2023-018683

(51) Int. Cl. H01M 50/188; H01M 50/593

(52) U.S. Cl. CPC H01M 50/188; H01M 50/593; H01M 2220/20

(57) ABSTRACT

A power storage device disclosed herein includes: a case body; a sealing plate having a terminal fit hole; an electrode body accommodated inside the case body; a collector terminal; and an insulating member arranged between the sealing plate and the collector termina. The insulating member is arranged at a periphery of the terminal fit hole of the sealing plate while being molded integrally with a peripheral portion of the terminal fit hole and the collector terminal. The power storage device has a substantially rectangular welded part provided along a boundary between the case body and the sealing plate. The welded part has a high-strength region formed in a part of a long side portion and in a neighborhood of a part where the sealing plate, the collector terminal and the insulating member are molded integrally, and having a penetration depth relatively greater than that in the other welded region.

### CROSS REFERENCE TO RELATED APPLICATION

The present application claims priority from Japanese Patent Application No. 2023-018683, filed on Feb. 9, 2023. The entire teachings of this application are incorporated into the present specification by reference.

### BACKGROUND OF THE DISCLOSURE

### 1. Field

The present disclosure relates to a power storage device.

### 2. Background

Secondary batteries such as lithium ion secondary batteries and capacitors such as lithium ion capacitors belong to so-called power storage devices that become widely used as portable power sources for personal computers or mobile terminals, and also as power sources for driving vehicles such as plug-in hybrid electric vehicles (PHEV), hybrid electric vehicles (HEV), and battery electric vehicles (BEV).

Power storage devices for such purposes of use include a power storage device having a configuration where an electrode body having a positive electrode and a negative electrode is accommodated in a metallic case of a so-called square form having a hexahedron shape composed of rectangular six sides. As a typical example, a power storage device having such a configuration includes a square case body with an opened one side and a rectangular plate-like sealing plate (lid) sealing this opening part, and respective collector terminals for a positive electrode and a negative electrode electrically connected to the positive electrode and the negative electrode respectively of an electrode body to be accommodated in a case are passed through respective terminal fit holes for the positive electrode and the negative electrode provided at the sealing plate to locate parts of the terminals on an outer surface of the sealing plate.

A power storage device of this type includes a sealed power storage device prepared as follows. While an insulating member made of synthetic resin is arranged in advance at a peripheral portion of the terminal fit hole, an assembly with the sealing plate and the collector terminal (hereinafter called a “collector terminal-sealing plate assembly”) is molded integrally using a predetermined die by fitting the collector terminal to the sealing plate while passing a part of the collector terminal through the fit hole. An electrode body having a predetermined shape is connected to the integrally-molded collector terminal-sealing plate assembly, and a resultant member is accommodated in a body of a case, and the sealing plate is joined to an opening part of the case.

For example, JP2021-86813A describes an example of a sealed power storage device (lithium ion secondary battery) manufactured by using such an integrally-molded collector terminal-sealing plate assembly.

### SUMMARY

Examination conducted by the present inventors shows that, in a power storage device where a collector terminal-sealing plate assembly such as that described in JP2021-86813A and a case body are welded to each other, it is likely that, as a result of the integral molding, rigidity will become higher at a part where a sealing plate, a collector terminal, and an insulating member are integrally molded than at the other part (a part not involved in the integral molding). Rigidity is likely to become low particularly at a welded part provided along a boundary between the sealing plate and the case body. This increases a difference in rigidity between the welded part and the integrally-molded part. If the sealing plate is subjected to a stress applied in a situation of some kind, the stress concentrates on the part of the relatively low rigidity. Hence, rupture is likely to occur at the welded part in a neighborhood of the integrally-molded part.

The present disclosure has been made in view of this issue, and an object of the present disclosure is intended to improve the safety to the power storage device in which a collector terminal-sealing plate assembly in which a collector terminal, an insulating member and sealing plate are molded integrally and a case body are welded.

A power storage device disclosed herein includes: a case body having an opening part; a sealing plate having a terminal fit hole and sealing the opening part; an electrode body accommodated inside the case body; a collector terminal having one end electrically connected to the electrode body inside the case body and the other end exposed on an outer surface side of the sealing plate; and an insulating member arranged between the sealing plate and the collector terminal. The insulating member is arranged at a periphery of the terminal fit hole of the sealing plate while being molded integrally with a peripheral portion of the terminal fit hole and the collector terminal. The sealing plate is a substantially rectangular plate member having long side portions in a pair facing each other and short side portions in a pair facing each other, the opening part of the case body has a substantially rectangular shape corresponding to that of the sealing plate, and a substantially rectangular welded part is provided along a boundary between the case body and the sealing plate. The welded part has a high-strength region formed in a part of the long side portions and in a neighborhood of a part where the sealing plate, the collector terminal and the insulating member are molded integrally, and having a penetration depth relatively greater than that in the other welded region.

In this configuration, the welded part has the high-strength region in a vicinity of the part where the sealing plate, the collector terminal and the insulating member are molded integrally and where apparent rigidity is high. This makes it possible to improve strength in a region partially where rupture is particularly likely to occur. As a result, it is possible to provide a power storage device with a high level of safety.

### BRIEF DESCRIPTION OF THE DRAWINGS

FIG. 1 is a perspective view schematically showing a battery according to an embodiment;

FIG. 2 is a view schematically showing an internal configuration of the battery according to an embodiment;

FIG. 3 is a view schematically showing the configuration of an electrode body;

FIG. 4 is a view schematically showing a collector terminal-sealing plate assembly where a sealing plate, a collector terminal, and an insulating member are molded integrally;

FIG. 5 is a sectional view schematically showing a collector terminal and the vicinity thereof according to an embodiment;

FIG. 6 is a plan view of FIG. 1;

FIG. 7 is view schematically showing the shape of a welded region and is a sectional view along a section perpendicular to a boundary surface between the sealing plate and a case body; and

FIG. 8 is a view schematically showing a molding die according to an embodiment.

### DETAILED DESCRIPTION OF THE PREFERRED EMBODIMENTS

Hereinafter, embodiments of a technology disclosed herein will be described by referring to the drawings. Any feature other than features specifically set forth in the present specification and necessary for carrying out the technology disclosed herein (such as a general configuration of and manufacturing process for a power storage device not characterizing the technology disclosed herein, for example) can be understood as a design matter that a person skilled in the art can address on the basis of conventional technology in the pertinent field. The technology disclosed herein can be carried out on the basis of a substance disclosed in the present specification and technical knowledge in the pertinent field. Each drawing is drawn schematically and dimensional relationships (length, width, thickness, etc.) do not necessarily reflect actual dimensional relationships. Moreover, in each drawing referred to below, members and parts having the same function will be given the same reference numerals, and redundant description thereof may be omitted or simplified. In addition, an expression “from A to B” indicating a range in the present specification (A and B are any numerical values) means a range equal to or greater than A and equal to or less than B.

In the present specification, a “power storage device” is a device where charging and discharging reactions occur in response to transfer of a charge carrier between electrodes in a pair (positive electrode and negative electrode) across an electrolyte. This power storage device includes: secondary batteries such as lithium ion secondary batteries, nickel hydride batteries, and nickel cadmium batteries; and capacitors such as lithium ion capacitors and electric double layer capacitors (namely, physical batteries).

Embodiments of the technology disclosed herein will be described below by using a lithium ion secondary battery as an example out of these power storage devices.

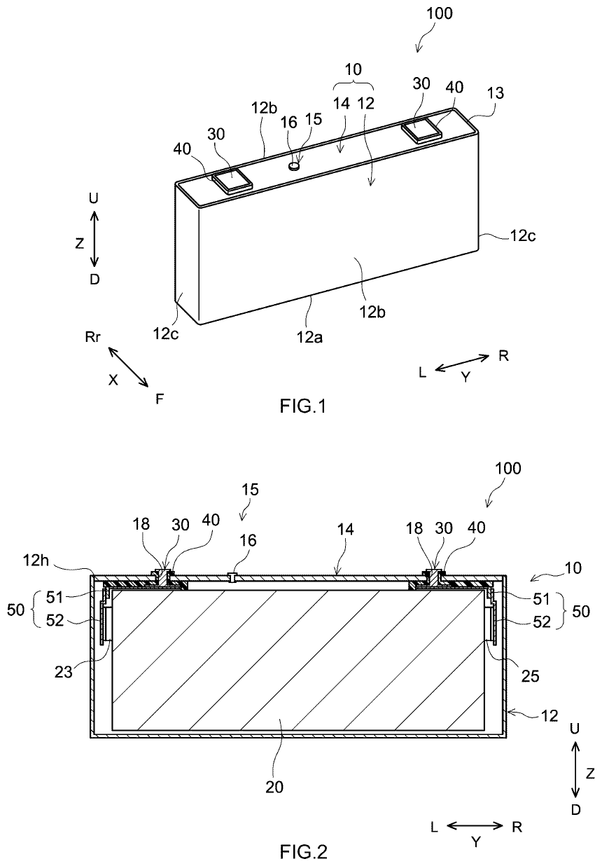

FIG. 1 is a perspective view of a secondary battery 100 according to the present embodiment. FIG. 2 is a view schematically showing an internal configuration of the secondary battery 100. In the following description, signs X, Y, and Z in the drawings indicate a short side direction of the secondary battery 100, and a long side direction perpendicular to the short side direction respectively, and a top-bottom direction. Furthermore, signs L, R, F, Rr, U, and D in the drawings indicate left, right, front, rear, up, and down respectively. However, these directions are defined for the convenience of description and are never intended to limit a way in which the secondary battery 100 is installed. Moreover, dimensional relationships (length, width, thickness, etc.) in each drawing do not necessarily reflect actual dimensional relationships.

As shown in FIGS. 1 and 2, the secondary battery 100 includes an electrode body 20, an electrolyte (not shown in the drawings), a case body 12 in which the electrode body 20 and the electrolyte are accommodated, a sealing plate 14, a collector terminal 30, and an insulating member 40.

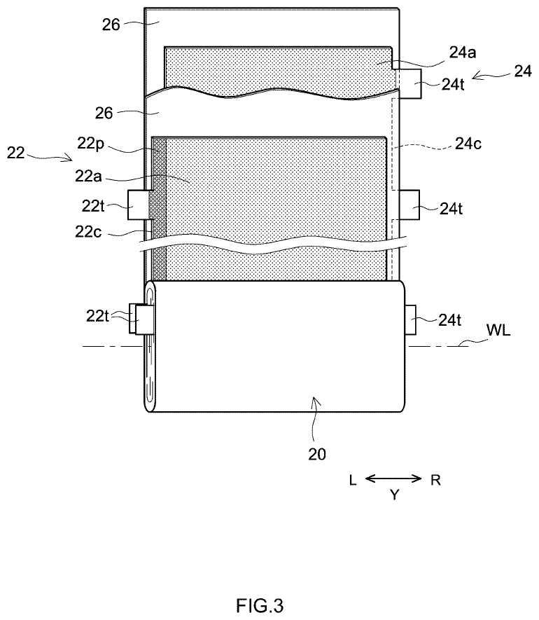

FIG. 3 is a view schematically showing the configuration of the electrode body 20. Here, as shown in FIG. 3, the electrode body 20 is a wound electrode body formed by laminating a strip-shape positive electrode sheet 22 and a strip-shape negative electrode sheet 24 on each other while insulation is provided therebetween across two strip-shape separators 26, and winding the laminated body about a winding axis WL in a lengthwise direction. Alternatively, the electrode body may be a laminated electrode body formed by laminating a square positive electrode sheet and a square negative electrode sheet on each other while insulation is provided therebetween across a square separator. Alternatively, the electrode body may be a laminated electrode body formed by laminating a square positive electrode sheet and a square negative electrode sheet on each other while insulation is provided therebetween across a serpentine separator.

As shown in FIG. 3, the positive electrode sheet 22 is an elongated strip-shape member. The configuration of the positive electrode sheet 22 is not particularly limited but can be similar to that used in a conventional publicly-known battery. For example, the positive electrode sheet 22 has a strip-shape positive electrode substrate 22c, and a positive electrode active material layer 22a and a positive electrode protective layer 22p arranged on at least one surface of the positive electrode substrate 22c. However, the positive electrode protective layer 22p is not essential but is omissible in other embodiments.

The positive electrode substrate 22c is an elongated strip-shape member. The positive electrode substrate 22c is composed of conductive metal such as aluminum, an aluminum alloy, nickel, or stainless steel, for example. Here, the positive electrode substrate 22c is metal foil, more specifically, aluminum foil. The size of the positive electrode substrate 22c is not particularly limited but can be determined properly in response to battery design. The positive electrode substrate 22c has one end portion in the long side direction Y (left end portion in FIG. 3) provided with a plurality of positive electrode tabs 22t. The positive electrode tabs 22t project further in the long side direction Y than the separator 26. The positive electrode tabs 22t are arranged at an interval (intermittently) in a lengthwise direction of the positive electrode substrate 22c. The positive electrode tab 22t forms part of the positive electrode substrate 22c and is composed of the metal foil (aluminum foil). The positive electrode active material layer 22a is formed in part of the positive electrode tab 22t. In at least part of the positive electrode tab 22t, the positive electrode active material layer 22a is not formed and the positive electrode substrate 22c is exposed. The positive electrode tabs 22t are laminated on one end portion of the long side direction Y (left end portion in FIG. 2) to form a positive electrode tab group 23. The positive electrode tabs 22t are folded and bent in such a manner as to align the respective outer edges thereof. The positive electrode tab group 23 is electrically connected to a positive electrode side collector terminal 30 across a collector 50.

As shown in FIG. 3, the positive electrode active material layer 22a is provided in a strip shape in the lengthwise direction of the positive electrode substrate 22c. The positive electrode active material layer 22a contains a positive electrode active material. The positive electrode active material to be used can be a publicly-known positive electrode active material used in lithium ion secondary batteries. As a specific example, the positive electrode active material to be used can be a lithium composite oxide or a lithium transition metal phosphate compound. These positive electrode active materials may each be used alone, or two or more types thereof may be used in combination. The positive electrode active material layer 22a may contain a component such as a conductive material or a binder, for example, other than the positive electrode active material. The conductive material to be used suitably may be carbon black such as acetylene black (AB) or other types of carbon materials (e.g., graphite), for example. The binder to be used may be polyvinylidene fluoride (PVDF), for example.

As shown in FIG. 3, the positive electrode protective layer 22p is provided at a boundary between the positive electrode substrate 22c and the positive electrode active material layer 22a in the long side direction Y. The positive electrode protective layer 22p may be a layer configured to be lower in electrical conductivity than the positive electrode active material layer 22a. Here, the positive electrode protective layer 22p is provided at one end portion of the positive electrode substrate 22c in the long side direction Y (left end portion in FIG. 3). Alternatively, the positive electrode protective layer 22p may be provided at the both end portions in the long side direction Y. The positive electrode protective layer 22p is provided in a strip shape along the positive electrode active material layer 22a. The positive electrode protective layer 22p contains an inorganic filler (alumina, for example). The positive electrode protective layer 22p may contain an optional component such as a conductive material, a binder, or each type of additive component, for example, other than the inorganic filler.

As shown in FIG. 3, the negative electrode sheet 24 is an elongated strip-shape member. The configuration of the negative electrode sheet 24 is not particularly limited but can be similar to that used in a conventional publicly-known battery. For example, the negative electrode sheet 24 has a negative electrode substrate 24c, and a negative electrode active material layer 24a arranged on at least one surface of the negative electrode substrate 24c.

The negative electrode substrate 24c is an elongated strip-shape member. The negative electrode substrate 24c is composed of conductive metal such copper, a copper alloy, nickel, or stainless steel, for example. Here, the negative electrode substrate 24c is metal foil, more specifically, copper foil. The size of the negative electrode substrate 24c is not particularly limited but can be determined properly in response to battery design. The negative electrode substrate 24c has one end portion in the long side direction Y (right end portion in FIG. 3) provided with a plurality of negative electrode tabs 24t. The negative electrode tabs 24t project further in the long side direction Y than the separator 26. The negative electrode tabs 24t are arranged at an interval (intermittently) in a lengthwise direction of the negative electrode sheet 24. The negative electrode tab 24t forms part of the negative electrode substrate 24c and is composed of the metal foil (copper foil). The negative electrode active material layer 24a is formed in part of the negative electrode tab 24t. In at least part of the negative electrode tab 24t, the negative electrode active material layer 24a is not formed and the negative electrode substrate 24c is exposed. The negative electrode tabs 24t are laminated on one end portion of the long side direction Y (right end portion in FIG. 2) to form a negative electrode tab group 25. The negative electrode tabs 24t are folded and bent in such a manner as to align the respective outer edges thereof. The negative electrode tab group 25 is electrically connected to a negative electrode side collector terminal 30 across a collector 50.

As shown in FIG. 3, the negative electrode active material layer 24a is provided in a strip shape in a lengthwise direction of the strip-shape negative electrode substrate 24c. The negative electrode active material layer 24a contains a negative electrode active material. While the negative electrode active material to be used is not particularly limited, it can be a carbon material such as graphite, hard carbon, or soft carbon, for example. The graphite may either be natural graphite or artificial graphite. The graphite may also be graphite coated with amorphous carbon having a configuration where graphite is coated with an amorphous carbon material. The negative electrode active material layer 24a may contain a component such as a binder or a thickening agent, for example, other than the negative electrode active material. The binder to be used may be styrene-butadiene rubber (SBR) or polyvinylidene fluoride (PVDF), for example. The thickening agent to be used may be carboxymethyl cellulose (CMC), for example.

The separator 26 is an insulating resin sheet with a plurality of fine through holes allowing a charge carrier to pass therethrough. The configuration of the separator 26 is not particularly limited but can be similar to that used in a conventional publicly-known battery. For example, the separator 26 is a porous sheet (film) composed of resin such as polyethylene (PE), polypropylene (PP), polyester, cellulose, or polyamide. A heat resistant layer (HRL) may be provided on a surface of the separator 26.

As described above, the secondary battery 100 includes the electrolyte. The electrolyte is not particularly limited but can be similar to that used in a conventional publicly-known battery. The electrolyte may contain a non-aqueous solvent (organic solvent) and an electrolytic salt (supporting salt), for example. For example, ethylene carbonate (EC), diethyl carbonate (DEC), dimethyl carbonate (DMC), or ethyl methyl carbonate (EMC) can be used as the non-aqueous solvent. Various lithium salts can be used as the supporting salt and in particular, lithium salts such as LiPF₆ and LiBF₄ are preferred. The electrolytic solution may contain various types of additives such as a film-forming agent, a gas generating agent, a dispersant, and a thickening agent, for example.

As shown in FIG. 1, a case 10 (here, battery case 10) includes the case body 12 and the sealing plate 14. Here, the battery case 10 has a rectangular solid (square) outer shape with a closed bottom. The battery case 10 can be formed using a conventional publicly-known material without any particular limitation. The battery case 10 (case body 12 and sealing plate 14) may be composed of aluminum, an aluminum alloy, stainless steel, iron, or an iron alloy, for example.

The case body 12 is a housing in which the electrode body 20 and the electrolyte are accommodated. The case body 12 is a square container with a closed bottom having one side surface (here, an upper surface) where an opening part 12h is provided (see FIG. 2). Here, the opening part 12h has a substantially rectangular shape. As shown in FIG. 1, the case body 12 includes a substantially rectangular bottom surface 12a in a plan view having long sides and short sides, longer walls 12b in a pair extending upward in the top-bottom direction Z from the long sides of the bottom surface 12a and facing each other, and shorter walls 12c in a pair extending upward in the top-bottom direction Z from the short sides of the bottom surface 12a and facing each other. The area of the shorter wall 12c is smaller than that of the longer wall 12b. While not particularly limited, the case body 12 has an average thickness (average plate thickness) that may generally be equal to or greater than 0.5 mm, for example, equal to or greater than 1 mm from the viewpoint of durability and the like. From the viewpoint of cost or energy density, the average plate thickness may generally be equal to or less than 3 mm and may be equal to or less than 2 mm, for example.

The sealing plate 14 is a substantially rectangular plate member having long side portions in a pair facing each other and short side portions in a pair facing each other. The sealing plate 14 is a member for closing the substantially rectangular opening part 12h of the case body 12. An outer edge of the sealing plate 14 and a peripheral portion of the opening part 12h of the case body 12 are weld connected to each other. The sealing plate 14 has an inner surface 14a (see FIG. 5) that is a surface on an inner side of the secondary battery 100 (a side facing the electrode body 20), and an outer surface 14b (see FIG. 5) that is a surface on an outer side of the secondary battery 100. As shown in FIG. 1, the sealing plate 14 faces the bottom surface 12a of the case body 12.

As shown in FIG. 2, the sealing plate 14 has two terminal fit holes 18 penetrating the sealing plate 14 in a thickness direction. The terminal fit holes 18 are provided one by one at opposite end portions of the sealing plate 14 in the long side direction Y. The terminal fit hole 18 on one side (left side in FIG. 2) is for a positive electrode and the terminal fit hole 18 on the other side (right side in FIG. 2) is for a negative electrode. Here, the shape of the terminal fit hole 18 in a plan view is a substantially perfect circle shape. Alternatively, the terminal fit hole 18 may have an oval shape or a polygonal shape such as a quadrangular shape or a hexagonal shape in a plan view. The shape of the terminal fit hole 18 may be selected properly in conformity with the shape of the collector terminal 30.

The sealing plate 14 is provided with a liquid filling hole 15 and a gas exhaust valve (not shown in the drawings). The liquid filling hole 15 is a through hole through which an electrolytic solution is filled into the battery case 10 after the sealing plate 14 is incorporated with the case body 12. The liquid filling hole 15 is sealed with a sealing member 16 after filling of the electrolytic solution. The gas exhaust valve is configured to rupture if a pressure in the battery case 10 becomes equal to or greater than a predetermined value, thereby exhausting gas in the battery case 10 to the outside.

While not particularly limited, the sealing plate 14 has an average thickness that may be equal to or greater than 0.3 mm, for example, equal to or greater than 0.5 mm from the viewpoint of durability and the like. From the viewpoint of cost or energy density, the average thickness may be equal to or less than 4 mm and may be equal to or less than 3 mm, for example. The average thickness of the sealing plate 14 may be smaller than an average thickness of the case body 12.

At the case body 12, a sealing plate support (not shown in the drawings) may be provided on inner wall surfaces of short side portions in a pair forming the peripheral portion of the opening part 12h. The sealing plate support is formed in such a manner as to project in a direction toward the inside of the case body 12. By doing so, the sealing plate 14 fitted in the opening part 12h is placed on the sealing plate support while being prevented from being sunk deeply from the opening part 12h. Thus, the outer surface 14b of the sealing plate 14 becomes arranged in such a manner as to be substantially flush with an upper surface of the adjacent peripheral portion of the opening part 12h. While the sealing plate support may be provided at the short side portion of the peripheral portion of the opening part 12h, it may be provided at four corners of the peripheral portion.

As shown in FIG. 2, the collector terminals 30 are provided one by one at the opposite end portions of the sealing plate 14 in the long side direction Y. The collector terminal 30 arranged on one side of the sealing plate 14 in the long side direction Y (left side in FIG. 2) is for a positive electrode, and the collector terminal 30 arranged on the other side (right side in FIG. 2) is for a negative electrode. The collector terminal 30 is inserted in the terminal fit hole 18 of the sealing plate 14. Preferably, the collector terminal 30 is composed of metal. Preferably, the collector terminal 30 for a positive electrode (namely, a positive electrode terminal) contains aluminum as a principal component. More specifically, the collector terminal 30 for a positive electrode is more preferably composed of aluminum or an aluminum alloy. Meanwhile, the collector terminal 30 for a negative electrode (namely, a negative electrode terminal) preferably contains copper as a principal component. More specifically, the collector terminal 30 for a negative electrode is more preferably composed of copper or a copper alloy, for example. Alternatively, the collector terminal 30 may be configured by joining and integrating two conductive members. For example, the positive electrode side collector terminal 30 may be configured by joining two different types of aluminum. A part of the collector terminal 30 for a negative electrode to be connected to the collector 50 may be composed of copper or a copper alloy, and a part thereof to be exposed on the outer surface 14b of the sealing plate 14 may be composed of aluminum or an aluminum alloy. The collector terminal 30 may be configured using a clad material composed of two metals, for example.

In the present specification, “containing A as a principal component” means that, of components forming the collector terminal, A is a maximum component based on mass.

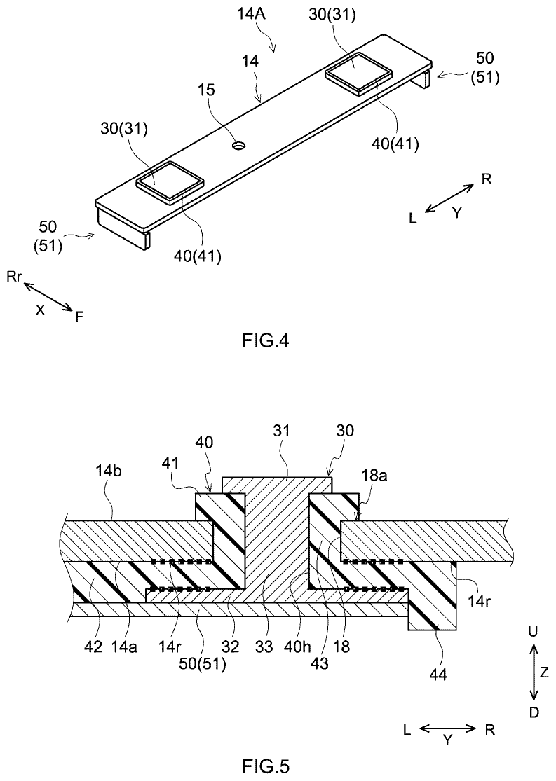

FIG. 4 is a view schematically showing a collector terminal-sealing plate assembly 14A where the sealing plate 14, the collector terminal 30, and the insulating member 40 are molded integrally. FIG. 5 is a schematic sectional view of the collector terminal 30 and the vicinity thereof. As shown in FIG. 4, the power storage device disclosed herein includes the collector terminal-sealing plate assembly 14A where the sealing plate 14, the collector terminal 30, and the insulating member 40 are molded integrally. In FIG. 4, the collector 50 is molded integrally in addition to the sealing plate 14, the collector terminal 30, and the insulating member 40.

As shown in FIG. 5, the collector terminal 30 is arranged in such a manner that a sealing plate outer surface side 31 thereof is exposed on an outer surface side of the sealing plate 14. The collector terminal 30 is arranged in such a manner that a sealing plate inner surface side 32 thereof is exposed on an inner surface side of the sealing plate 14. As shown in FIG. 5, the sealing plate outer surface side 31 of the collector terminal 30 is formed into a size allowing the sealing plate outer surface side 31 to be inserted in the terminal fit hole 18. Meanwhile, the sealing plate inner surface side 32 of the collector terminal 30 is configured to have an outer diameter greater than the terminal fit hole 18. By doing so, it becomes possible to perform integral molding (insert molding) described later favorably. The outer diameter of the sealing plate inner surface side 32 is greater than that of the sealing plate outer surface side 31. The shape of each of the sealing plate outer surface side 31 and the sealing plate inner surface side 32 of the collector terminal 30 in a plan view is not particularly limited. The shape of each of the sealing plate outer surface side 31 and the sealing plate inner surface 32 in a plan view may be a polygonal shape such as a triangular shape, a quadrangular shape, or a hexagonal shape, or may be a perfect circle shape or an oval shape.

The collector terminal 30 is connected to the electrode body 20 across the collector 50 inside the battery case 10. More specifically, the positive electrode side collector 50 connects the positive electrode tab group 23 composed of the positive electrode tabs 22t and the positive electrode side collector terminal 30 to each other. The negative electrode side collector 50 connects the negative electrode tab group 25 composed of the negative electrode tabs 24t and the negative electrode side collector terminal 30 to each other. As shown in FIG. 2, the collector 50 includes a first collector unit 51 extending in the long side direction Y, and a second collector unit 52 extending along the shorter wall 12c of the case body 12, for example. The collector 50 may be composed of metal having conductivity such as aluminum, an aluminum alloy, nickel, or stainless steel, for example. The collector 50 and the collector terminal 30 are joined to each other by welding such as ultrasonic welding, resistance welding, or laser welding, for example. Alternatively, the collector 50 may be joined by being molded integrally with the sealing plate 14 together with the collector terminal 30 in an integral molding step described later. The collector 50 and the collector terminal 30 may also be joined to each other by mechanical working such as swaging (riveting).

The first collector unit 51 is arranged between the sealing plate 14 and the electrode body 20. The first collector unit 51 extends horizontally along the inner surface 14a of the sealing plate 14. As shown in FIG. 5, the insulating member 40 is arranged between the sealing plate 14 and the first collector unit 51. The first collector unit 51 is insulated from the sealing plate 14 by the insulating member 40. The first collector unit 51 is connected to the sealing plate inner surface side 32 of the collector terminal 30. As shown in FIG. 2, the second collector unit 52 is connected to the first collector unit 51 on one side (upper side in FIG. 2) in the top-bottom direction Z and is connected to the positive electrode tab group 23 or the negative electrode tab group 25 on the other side (lower side in FIG. 2).

The insulating member 40 is a member that prevents electrical continuity between the sealing plate 14 and the collector terminal 30. As shown in FIG. 5, the insulating member 40 is arranged at a periphery 18a of the terminal fit hole 18 of the sealing plate 14 while being molded integrally with a peripheral portion of the terminal fit hole 18 and the collector terminal 30. In the present specification, “the periphery of the terminal fit hole” includes not only an edge of the terminal fit hole but also a region around the edge. More specifically, the periphery of the terminal fit hole includes a region within 10 mm (for example, within 5 mm) from an end (edge) of the terminal fit hole.

The insulating member 40 is composed of a fluorine-based resin such as perfluoroalkoxy alkane (PFA) or polytetrafluoroethylene (PTFE) or a synthetic resin material such as polyphenylene sulfide (PPS). Of these materials, the insulating member 40 is preferably composed of polyphenylene sulfide for reason that this material makes it possible to ensure sufficient joint strength.

As shown in FIG. 5, the insulating member 40 includes a first flange part 41, a second flange part 42, a cylindrical part 43, and a projecting part 44. The first flange part 41, the second flange part 42, the cylindrical part 43, and the projecting part 44 are formed integrally. The insulating member 40 has a through hole 40h penetrating the insulating member 40 in the top-bottom direction Z at a position corresponding to the terminal fit hole 18 of the sealing plate 14. The first flange part 41 is arranged on the outer surface side of the sealing plate 14 to insulate the sealing plate outer surface side 31 of the collector terminal 30 and the outer surface 14b of the sealing plate 14 from each other. As shown in FIG. 4, the first flange part 41 projects further externally than the collector terminal 30 in a plan view and is exposed to the outside. The second flange part 42 is arranged on the inner surface side of the sealing plate 14 to insulate the sealing plate inner surface side 32 of the collector terminal 30 and the inner surface 14a of the sealing plate 14 from each other. The second flange part 42 extends in a horizontal direction along the inner surface 14a of the sealing plate 14. The first flange part 41 and the second flange part 42 have outer shapes larger than the outer shapes of the sealing plate outer surface side 31 and the sealing plate inner surface side 32 of the collector terminal 30 respectively.

The cylindrical part 43 is located between the terminal fit hole 18 and a shaft part 33 of the collector terminal 30. The cylindrical part 43 insulates the terminal fit hole 18 and the shaft part 33 from each other. As shown in FIG. 5, the projecting part 44 is provided closer to the center of the sealing plate 14 than the second flange part 42 in the long side direction Y. The projecting part 44 extends downward in the top-bottom direction Z from one end portion of the second flange part 42 in the long side direction Y (right end portion in FIG. 5). The projecting part 44 may face a bent part of the electrode body 20. Thus, even if the electrode body 20 moves to some extent in response to application of vibration or impact during use of the secondary battery 100, it is still possible to reduce a likelihood that the electrode body 20 will contact the sealing plate 14 directly.

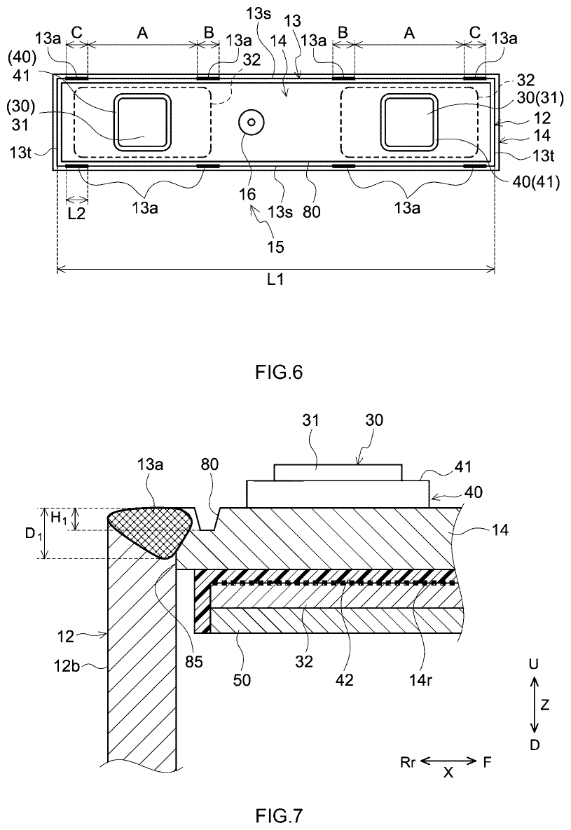

FIG. 6 is a plan view of FIG. 1. FIG. 7 is view schematically showing the shape of a welded region and is a sectional view along a section perpendicular to a boundary surface 85 between the sealing plate 14 and the case body 12. As shown in FIG. 6, the outer edge of the sealing plate 14 and the peripheral portion of the opening part 12h of the case body 12 are weld connected to each other to form a welded part 13 along a boundary (fit part) between the case body 12 and the sealing plate 14. The opening part 12h of the case body 12 is closed tightly with the sealing plate 14, allowing the battery case 10 to be sealed hermetically.

The welded part 13 may be formed by weld connection such as laser welding, for example. The welded part 13 is a part formed by melting of metal forming the case body 12 and melting of metal forming the sealing plate 14 resulting from laser welding of the fit part between the case body 12 and the sealing plate 14. The welded part 13 is located on the outer surface side of the sealing plate 14. At the welded part 13, an inner periphery of the opening part 12h of the case body 12 and an outer periphery of the sealing plate 14 are coupled to each other in such a manner as to be flush with each other. The welded part 13 is formed along an entire perimeter of the fit part between the sealing plate 14 and the case body 12. The welded part 13 is formed continuously in a substantially rectangular shape along the fit part between the sealing plate 14 and the case body 12 in a plan view, and has long side portions 13s in a pair facing each other and short side portions 13t in a pair facing each other.

As shown in FIG. 6, the welded part 13 of the power storage device disclosed herein has a high-strength region 13a. The high-strength region 13a is disposed in a part of the long side portion 13s and in a vicinity of a part where the sealing plate 14, the collector terminal 30 and the insulating member 40 are molded integrally. The high-strength region 13a has a penetration depth relatively greater than that in the other welded region. As the penetration depth is greater (a weld depth is greater) in the high-strength region 13a than in the other welded region, strength is high in the high-strength region 13a. The power storage device disclosed herein includes the collector terminal-sealing plate assembly 14A where the sealing plate 14, the collector terminal 30, and the insulating member 40 are molded integrally. The members forming the collector terminal-sealing plate assembly 14A are joined firmly to each other in such a manner that joint strength satisfies a predetermined criterion. For this reason, apparent rigidity is increased sharply at a part of the sealing plate 14 molded integrally with the collector terminal 30 and the insulating member 40. On the other hand, rigidity is relatively low at the welded part 13 not involved in the integral molding. On the occurrence of such a difference in rigidity in the power storage device, stress concentrates in the part of low rigidity at a boundary between the part of high rigidity (namely, the integrally-molded part) and the part of low rigidity (namely, the welded part 13) so rupture is caused easily particularly in the part of low rigidity. In response to this, by providing the high-strength region 13a to the welded part 13 in the neighborhood of the part where the sealing plate 14, the collector terminal 30, and the insulating member 40 are molded integrally, it becomes possible to increase strength partially in the region where rupture is likely to occur. By doing so, the rupture strength of the power storage device is increased effectively, making it possible to provide the power storage device with a higher level of safety.

The high-strength region 13a of the welded part 13 is a region provided at a place where stress concentration resulting from a difference in rigidity such as that described above is likely to occur at the welded part 13. Strength is higher in the high-strength region 13a than in the other welded region. More specifically, a penetration depth is relatively greater in the high-strength region 13a than in a region of the welded part 13 other than the high-strength region 13a. For example, the high-strength region 13a is a region formed in such a manner that a penetration depth therein becomes greater than an average penetration depth along an entire perimeter of the welded part 13. The high-strength region 13a may be a region formed in such a manner that a penetration depth therein becomes greater than that in the short side portion 13t of the welded part 13. This makes it possible to improve strength partially in the place where stress concentration is likely to occur at the welded part 13, so that the occurrence of rupture of the secondary battery 100 can be reduced effectively.

The penetration depth (weld depth) means a length in a direction along the boundary surface 85 between the sealing plate 14 and the case body 12 (a length in the top-bottom direction Z in FIG. 7). The penetration depth can be measured by observing a section of the welded part 13 under a microscope, for example. The penetration depth becomes adjustable by changing a condition for the welding. For example, the penetration depth can be increased by increasing emission output a laser beam or increasing a duration of the emission during welding of the high-strength region 13a, compared to welding of the other welded region. Alternatively, the penetration depth can be increased by adjusting the depth or width of a groove portion 80 described later.

While not particularly limited, a penetration depth D1 in the high-strength region 13a is at a ratio that is preferably equal to or greater than 1.1 to a penetration depth D2 in the welded region other than the high-strength region 13a (D1/D2). This allows strength in the high-strength region 13a to be improved properly, so that the occurrence of rupture can be reduced in a neighborhood of the part where the sealing plate 14, the collector terminal 30 and the insulating member 40 are molded integrally. The ratio of the penetration depth D1 in the high-strength region 13a to the penetration depth D2 in the welded region than the high-strength region 13a (D1/D2) is preferably equal to or greater than 1.2, more preferably, equal to or greater than 1.3. While not particularly limited, the ratio of the penetration depth D1 in the high-strength region 13a to the penetration depth D2 in the welded region other than the high-strength region 13a (D1/D2) is preferably equal to or less than 1.5. For example, the ratio (D1/D3) of the penetration depth D1 in the high-strength region 13a to a penetration depth D3 in the short side portion 13t of the welded part 13 is at a ratio that is preferably from 1.1 to 1.5.

While not particularly limited, the high-strength region 13a may be provided only in one of a vicinity of a part where the positive electrode side collector terminal 30, the sealing plate 14, and the insulating member 40 are molded integrally and a vicinity of a part where the negative electrode side collector terminal 30, the sealing plate 14, and the insulating member 40 are molded integrally. Preferably, the high-strength region 13a is provided both in the vicinity of the part where the positive electrode side collector terminal 30, the sealing plate 14, and the insulating member 40 are molded integrally and in the vicinity of the part where the negative electrode side collector terminal 30, the sealing plate 14, and the insulating member 40 are molded integrally.

In the welded part 13, the high-strength region 13a is arranged in a part of the long side portion 13s of the welded part 13 having a substantially rectangular shape. The high-strength region 13a of the welded part 13 may be arranged in a vicinity of an end portion of the sealing plate inner surface side 32 of the collector terminal 30 in the long side direction Y. The vicinity of the end portion of the sealing plate inner surface side 32 in the long side direction Y is a place where the integrally-molded part and the part not involved in the integral molding are switched from each other. Hence, stress is likely to concentrate in the neighborhood region of the end portion of the sealing plate inner surface side 32 in the long side direction Y so rupture is likely to occur at the welded part 13. By providing the high-strength region 13a where strength is partially high in the neighborhood region of the end portion of the sealing plate inner surface side 32, it becomes possible to improve rupture strength more favorably.

As described above, the high-strength region 13a may be arranged in the long side portion 13s of the welded part 13 and in a vicinity of both end portions of the sealing plate inner surface side 32 in the long side direction Y. More specifically, in the long side portion 13s of the welded part 13, with a region having a length 0.8 times the length of the sealing plate inner surface side 32 of the collector terminal 30 in the long side direction Y defined as a region A. With a region extending toward the center of the sealing plate 14 from an end portion of the region A closer to the center in the long side direction Y and having a length 0.2 times the length of the region A defined as a region B. With a region extending toward the outer edge of the sealing plate 14 from an end portion of the region A closer to the outer edge in the long side direction Y and having a length 0.2 times the length of the region A in the long side direction Y defined as a region C. The high-strength region 13a is preferably arranged in the region B and/or the region C.

The high-strength region 13a may be arranged only in the region B or only in the region C. Preferably, the high-strength region 13a may be arranged both in the region B and the region C. While not particularly limited, if the high-strength region 13a is arranged in one of the region B and the region C from the viewpoint of production cost, for example, the high-strength region 13a may be arranged in the region B (namely, in the long side portion 13s of the welded part 13 and in a neighborhood of an end portion of the sealing plate inner surface side 32 closer to the center in the long side direction Y). If a pressure inside the case is increased for some reason, stress concentration is more likely to occur in a place closer to the center than in a place closer to the outer edge of the sealing plate 14 in the long side direction Y. In response to this, arranging the high-strength region 13a in the region B makes it possible to improve rupture strength more favorably.

While not particularly limited, with a length L1 of the long side portion 13s of the welded part 13 in the long side direction Y defined as 100%, the high-strength region 13a has a length L2 in the long side direction Y that is preferably equal to or greater than 5%. The length L2 of the high-strength region 13a less than 5% of the length L1 of the long side portion 13s of the welded part 13 is not preferred as it makes it impossible to ensure sufficient strength on the occurrence of stress concentration to cause a risk of rupture. If a penetration depth is increased (laser output is increased) throughout the welded part 13 entirely for ensuring strength, weld failure such as spatter, void, or weld burning (weld scorching) may occur with a higher probability. Furthermore, in this case, such a laser possessing a high output is required to be prepared which is unfavorable from the viewpoint of production cost. While not particularly limited, from the viewpoint of reducing the occurrence of the weld failure or reducing production cost, with the length L1 of the long side portion 13s of the welded part 13 defined as 100%, the length L2 of the high-strength region 13a is preferably equal to or less than 15%. With the length L1 of the long side portion 13s of the welded part 13 defined as 100%, the length L2 of the high-strength region 13a in the long side direction Y is preferably equal to or greater than 5% and equal to or less than 15%, for example, more preferably, equal to or greater than 5% and equal to or less than 10%.

As shown in FIGS. 6 and 7, the sealing plate 14 preferably includes the groove portion 80 arranged closer to an inner periphery than the welded part 13 in a radial direction of the sealing plate 14. The groove portion 80 is formed continuously into a substantially rectangular shape smaller than the welded part 13 in a plan view. The heat of a laser beam emitted in weld connecting the case body 12 and the sealing plate 14 to each other is likely to escape from an intended position (here, a boundary between the case body 12 and the sealing plate 14) to a different place to make the energy of the laser beam hard to stay in the boundary. By providing the groove portion 80 closer to the inner periphery than the welded part 13 in a radial direction of the sealing plate 14, it becomes possible for the energy of the laser beam to stay easily in the intended position during the weld connection.

The foregoing effect by keeping the energy of a laser beam may be exerted further with increase in the groove depth of the groove portion 80 (a length in the thickness direction of the sealing plate 14, which is a length in the top-bottom direction Z in FIG. 7). Thus, the groove depth is preferably greater in a neighborhood of the high-strength region 13a than in other regions. This allows a penetration depth to be increased favorably in the high-strength region 13a. While not particularly limited, a ratio (H1/H2) of a groove depth H1 in a vicinity of the high-strength region 13a to a groove depth H2 of the groove portion 80 in a vicinity of the short side portion 13t of the welded part 13 is from 1.05 to 1.2.

As shown in FIGS. 5 and 7, in the collector terminal-sealing plate assembly 14A, a roughened area 14r resulting from roughening treatment is preferably arranged in at least a part of surfaces of the sealing plate 14 and the collector terminal 30. The roughening treatment is a surface treatment of forming irregularities on a surface to increase a surface area and enhance an anchor effect, thereby improving performance of joining or tight contact between the insulating member 40 and the sealing plate 14. Thus, the roughened area 14r is an area with more irregularities than a surrounding of the roughened area 14r.

The roughened area 14r may be provided in the sealing plate 14. Preferably, the roughened area 14r is arranged in at least a part of a surface of the sealing plate 14 contacting the insulating member 40, for example. In another case, the roughened area 14r may be arranged in the collector terminal 30. Preferably, the roughened area 14r is arranged in a surface where the collector terminal 30 and the insulating member 40 contact each other. The roughened area 14r may be arranged in the sealing plate outer surface side 31, the sealing plate inner surface side 32 of the collector terminal 30, or both in these sides. In a place in the presence of the roughened area 14r, the anchor effect is fulfilled as described above so rigidity is likely to increase particularly in this place. Specifically, rigidity is high particularly in a place where the roughened area 14r is provided in the sealing plate 14 and/or the collector terminal 30 and the sealing plate 14 and the collector terminal 30 are molded integrally with the insulating member 40.

While not particularly limited, the high-strength region 13a of the welded part 13 may be arranged in a vicinity of a place located in the part where the sealing plate 14, the collector terminal 30, and the insulating member 40 are molded integrally and the roughened area 14r may be disposed in the sealing plate 14 and/or the collector terminal 30. In a place where a roughened position and a non-roughened position are switched from each other, stress is likely to concentrate locally so rupture is likely to occur at the position of the switching. Thus, providing the high-strength region 13a of partially high strength in the position of the switching makes it possible to improve rupture strength favorably.

### <Method of Manufacturing Power Storage Device>

A lithium ion secondary battery will be described below as an example of a preferred embodiment of a method of manufacturing the power storage device disclosed herein. However, this is not intended to limit a target of application of the method to such a battery.

The method of manufacturing the secondary battery 100 may include a step of preparing the sealing plate 14, the collector terminal 30, and other required members, a step of integrally molding the sealing plate 14 and the collector terminal 30, and a step of weld connecting the collector terminal-sealing plate assembly 14A resulting from the integral molding and the case body 12 to each other. The method may include a different additional step in an optional stage.

In the preparing step, the sealing plate 14, the collector terminal 30, and the electrode body 20 are prepared. The electrode body 20 can be produced by following a publicly-known method. As shown in FIG. 3, if the electrode body 20 is a wound electrode body, the wound electrode body can be prepared as follows, for example. First, the strip-shape positive electrode sheet 22 and the strip-shape negative electrode sheet 24 are laminated on each other while insulation is provided therebetween across the two strip-shape separators 26. At this time, the positive electrode sheet 22 and the negative electrode sheet 24 are superimposed on each other in such a manner that the positive electrode tab 22t of the positive electrode sheet 22 and the negative electrode tab 24t of the negative electrode sheet 24 stick out from the end portions of the two separators 26 in the long side direction Y toward directions opposite to each other. Next, the prepared laminated body is wound in the lengthwise direction about a winding axis. The laminated body can be wound by following a publicly-known method. The wound laminated body is pressed to produce a wound electrode body having a flat shape. This pressing is not particularly limited but can be performed using a publicly-known press unit used in manufacturing a general wound electrode body having a flat shape. In this way, the electrode body 20 can be prepared.

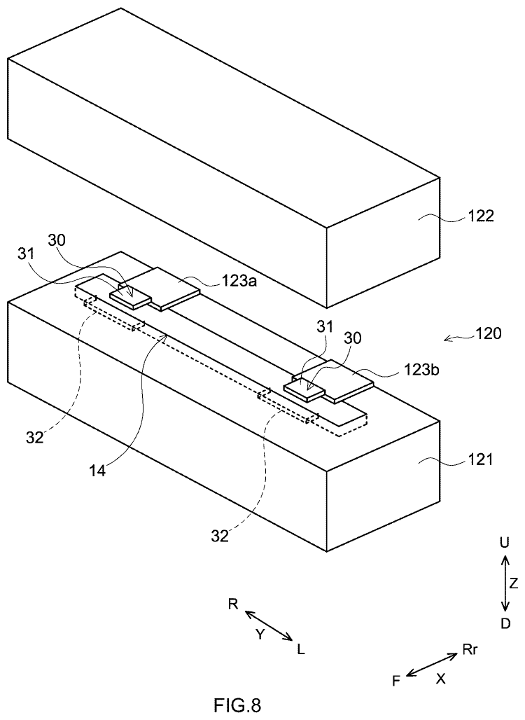

FIG. 8 is a view schematically showing a molding die 120. In the integral molding step, the sealing plate 14 and the collector terminal 30 are integrated with each other through insert molding to produce the collector terminal-sealing plate assembly 14A. The insert molding can be performed by following a publicly-known method. More specifically, the insert molding can be performed using the molding die 120 with a lower die 121 and an upper die 122 such as those shown in FIG. 8 and by following a method including a component setting step, a positioning step, an upper die setting step, an injection molding step, an upper die releasing step, and a component extracting step.

In the component setting step, the sealing plate 14 and the collector terminal 30 are loaded into the molding die 120. First, the collector terminal 30 is inserted into the terminal fit hole 18 of the sealing plate 14. As described above, the collector terminal 30 is formed into a size allowing the sealing plate outer surface side 31 to be inserted in the terminal fit hole 18. Thus, the collector terminal 30 is inserted into each of the two terminal fit holes 18 from the sealing plate outer surface side 31. Then, the sealing plate 14 with the collector terminal 30 inserted in each of the two terminal fit holes 18 is loaded into a recess 121a of the lower die 121.

In the positioning step, the sealing plate 14 and the collector terminal 30 are placed into positions. After the sealing plate 14 and the collector terminal 30 are loaded in the lower die 121, the positioning step is started in response to predetermined operation such as switch depression, for example. More specifically, in response to the predetermined operation such as switch depression, a slide member 123a and a slide member 123b at backward retreating positions move forward. Then, the collector terminals 30 are caught by the respective slide members 123a and 123b. The collector terminals 30 are supported by the respective slide members 123a and 123b and located at intended positions.

In the upper die setting step, the upper die 122 is set in such a manner as to interpose the sealing plate 14 and the collector terminal 30 in the top-bottom direction Z placed in the lower die 121. While not shown in the drawings, the upper die 122 may have a seal part to abut on the lower die 121, a resin supplier to supply resin, and a recess into which the supplied resin is to flow. The recess of the upper die 122 is arranged in such a manner as to face the recess 121a of the lower die 121 across the sealing plate 14 and the collector terminal 30.

In the injection molding step, resin is supplied (injected) from the resin supplier to mold the sealing plate 14 and the collector terminal 30 integrally. In the injection molding step, the molding die 120 is heated first. While a heating temperature is not particularly limited as it differs according to a resin type, it may approximately be from 100 to 200° C., for example. After heating of the molding die 120 is finished, melted resin is supplied from the resin supplier. The supplied resin is filled into the recess of the upper die 122 and further filled into the recess 121a of the lower die 121 through the terminal fit hole 18. Then, the molding die 120 and the molded item are cooled. By doing so, the sealing plate 14 and the collector terminal 30 can be molded integrally.

In the upper die releasing step, the upper die 122 moves up to be separated from the lower die 121. Next, in the component extracting step, the molded item is detached from the lower die 121. As a result, the collector terminal-sealing plate assembly 14A can be produced where the collector terminal 30 and the sealing plate 14 are molded integrally. A step of removing burrs occurring during the molding may be performed after the component extracting step.

In the welding step, while the prepared electrode body 20 is accommodated inside the case body 12, the collector terminal-sealing plate assembly 14A and the case body 12 are welded to each other, thereby hermetically sealing the secondary battery 100. More specifically, first, the second collector unit 52 and the electrode body 20 are connected to each other. Next, the first collector unit 51 is mounted on the collector terminal 30 of the collector terminal-sealing plate assembly 14A. Then, the first collector unit 51 and the second collector unit 52 are connected to each other. By doing so, it becomes possible to connect the collector terminal-sealing plate assembly 14A and the electrode body 20 to each other. The electrode body 20 mounted on the collector terminal-sealing plate assembly 14A is inserted through the opening part 12h of the case body 12. At this time, the electrode body 20 may be inserted in such a manner as to be placed inside the case body 12 in a direction in which the winding axis WL of the electrode body 20 extends along the bottom surface 12a (specifically, in a direction in which the winding axis WL extends parallel to the long side direction Y).

Next, while the electrode body 20 is accommodated inside the case body 12, the collector terminal-sealing plate assembly 14A and the periphery of the opening part 12h of the case body 12 are joined to each other by laser welding. The joining proceeds in such a manner that an upper end of the opening peripheral portion of the case body 12 and the outer surface 14b of the sealing plate 14 become flush with each other. Then, a laser beam is emitted from an outer surface side of the battery case 10 toward the boundary (fit part) between the case body 12 and the sealing plate 14. A type of the laser beam used for the laser welding or a condition for the laser welding may be similar to those in a conventional case and are not particularly limited. An angle formed between a direction of the laser emission and the outer surface 14b of the sealing plate 14 (horizontal surface) may approximately be 90±10° and may also approximately be 90±5°, for example. During the laser welding, emission output in a neighborhood of the part where the sealing plate 14, the collector terminal 30, and the insulating member 40 are molded integrally is increased so as to provide a penetration depth greater in the neighborhood than in the other welded region. By doing so, the high-strength region 13a can be formed favorably in the vicinity of the part where the sealing plate 14, the collector terminal 30, and the insulating member 40 are molded integrally. The weld connection is formed along an entire perimeter of the boundary (fit part) between the case body 12 and the sealing plate 14, thereby sealing the case body 12 and the sealing plate 14 tightly with each other.

After the welding step, the electrolytic solution is filled from the liquid filling hole 15 and the liquid filling hole 15 is sealed with the sealing member 16, thereby hermetically sealing the secondary battery 100. In this way, the secondary battery 100 can be manufactured.

### <Purpose of Use of Battery>

The power storage device is available for various purposes of use and can be used suitably as a power source (driving power source) for motors installed on vehicles such as passenger cars or trucks, for example. While a vehicle type is not particularly limited, examples thereof include plug-in hybrid electric vehicles (PHEV), hybrid electric vehicles (HEV), and battery electric vehicles (BEV), for example. The power storage device is also used suitably in a configuration formed by arranging a plurality of such power storage devices in a predetermined arrangement direction and applying a load in the arrangement direction from a binding mechanism (for example, an assembled battery configured by arranging a plurality of lithium ion secondary batteries in a predetermined direction).

While some embodiments of the present disclosure have been described above, the embodiments are mere examples. The present disclosure can be carried out in various other embodiments. The present disclosure can be carried out on the basis of the contents disclosed in the present specification and technical knowledge in the pertinent field. The technology described in the claims include various modifications and changes from the embodiments described above as examples. For example, it is possible to replace some of the embodiments with other modifications or add other modifications to the embodiments. Unless one technical feature is described as being essential, this feature can be eliminated, as appropriate.

As described above, specific configurations of the technology disclosed herein can be provided in each of the following items.

Item 1: A power storage device including: a case body having an opening part; a sealing plate having a terminal fit hole and closing the opening part; an electrode body accommodated inside the case body; a collector terminal having one end electrically connected to the electrode body inside the case body and the other end exposed on an outer surface side of the sealing plate; and an insulating member arranged between the sealing plate and the collector terminal, wherein the insulating member is arranged at a periphery of the terminal fit hole of the sealing plate while being molded integrally with a peripheral portion of the terminal fit hole and the collector terminal, the sealing plate is a substantially rectangular plate member having long side portions in a pair facing each other and short side portions in a pair facing each other, the opening part of the case body has a substantially rectangular shape corresponding to that of the sealing plate, a substantially rectangular welded part is provided along a boundary between the case body and the sealing plate, and the welded part has a high-strength region formed in a part of the long side portions and in a neighborhood of a part where the sealing plate, the collector terminal and the insulating member are molded integrally, and having a penetration depth relatively greater than those in the other welded regions.

Item 2: The power storage device according to Item 1, wherein a ratio (D1/D2) of a penetration depth D1 in the high-strength region of the welded part to a penetration depth D2 in the welded region other than the high-strength region of the welded part is 1.1 to 1.5.

Item 3: The power storage device according to Item 1 or 2, wherein the high-strength region is arranged in the long side portions of the welded part and in a vicinity of an end portion of a sealing plate inner surface side of the collector terminal in a long side direction.

Item 4: The power storage device according to any one of Items 1 to 3, wherein a length of the high-strength region along the long side direction is equal to or greater than 5% and equal to or less than 15% when a length of the long side portions of the welded part defined as 100%.

Item 5: The power storage device according to any one of Items 1 to 4, wherein the sealing plate has a groove portion arranged closer to an inner periphery than the welded part in a radial direction of the sealing plate, and
a ratio (H1/H2) of a groove depth H1 in a vicinity of the high-strength region to a groove depth H2 of the groove portion in a vicinity of the short side portions of the welded part is 1.05 to 1.2.

What is claimed is:

1. A power storage device comprising:
a case body having an opening part;
a sealing plate having a terminal fit hole and sealing the opening part;
an electrode body accommodated inside the case body;
a collector terminal having one end electrically connected to the electrode body inside the case body and the other end exposed on an outer surface side of the sealing plate; and
an insulating member arranged between the sealing plate and the collector terminal, wherein
the insulating member is arranged at a periphery of the terminal fit hole of the sealing plate while being molded integrally with a peripheral portion of the terminal fit hole and the collector terminal,
the sealing plate is a substantially rectangular plate member having long side portions in a pair facing each other and short side portions in a pair facing each other,
the opening part of the case body has a substantially rectangular shape corresponding to that of the sealing plate,
a substantially rectangular welded part is arranged along a boundary between the case body and the sealing plate, and
the welded part has a high-strength region formed in a part of the long side portions and in a vicinity of a part where the sealing plate, the collector terminal and the insulating member are molded integrally, and having a penetration depth relatively greater than that in the other welded region.

2. The power storage device according to claim 1, wherein
a ratio (D1/D2) of a penetration depth D1 in the high-strength region of the welded part to a penetration depth D2 in the welded region other than the high-strength region of the welded part is 1.1 to 1.5.

3. The power storage device according to claim 1, wherein
the high-strength region is arranged in the long side portions of the welded part and in a vicinity of an end portion of a sealing plate inner surface side of the collector terminal in a long side direction.

4. The power storage device according to claim 1, wherein
a length of the high-strength region along the long side direction is equal to or greater than 5% and equal to or less than 15% when a length of the long side portions of the welded part defined as 100%.

5. The power storage device according to claim 1, wherein
the sealing plate has a groove portion arranged closer to an inner periphery than the welded part in a radial direction of the sealing plate, and
a ratio (H1/H2) of a groove depth H1 in a vicinity of the high-strength region to a groove depth H2 of the groove portion in a vicinity of the short side portions of the welded part is 1.05 to 1.2.
